(19) United States
(12) Patent Application Publication
(10) Pub. No.: US 2011/0191854 A1
(43) Pub. Date: Aug. 4, 2011

(54) METHODS AND SYSTEMS FOR TESTING AND ANALYZING VULNERABILITIES OF COMPUTING SYSTEMS BASED ON EXPLOITS OF THE VULNERABILITIES

(76) Inventors: Anastasios Giakouminakis, Los Angeles, CA (US); Chad Loder, Los Angeles, CA (US); Corey E. Thomas, Boston, MA (US); H. D. Moore, Austin, TX (US)

(21) Appl. No.: 12/750,031

(22) Filed: Mar. 30, 2010

Related U.S. Application Data
(60) Provisional application No. 61/299,763, filed on Jan. 29, 2010.

(51) Int. Cl. G06F 21/00

(52) U.S. Cl. 726/25

(57) ABSTRACT

A security tool can identify vulnerabilities in a computing system and determine a risk level of the vulnerabilities. The security tool can determine the risk level based on exploits associated with the vulnerabilities. The security tool can determine the risk level based on factors associated with the exploits such as whether an exploit exists, a rank of the exploit, a number of exploits that exist for the vulnerability, a difficulty to identify whether the exploit exists, and an effect of the exploit on the vulnerability. The security tool can a report identifying the vulnerabilities of the computing system, the exploits associated with the vulnerabilities, and the risk level of the vulnerabilities. The report can also include links to information about the exploits.

### CROSS-REFERENCE TO RELATED APPLICATIONS

This application claims priority to U.S. Provisional Patent Application Ser. No. 61/299,763 filed on Jan. 29, 2010, the disclosure of which is incorporated in its entirety by reference herein.

### FIELD

Aspects of the disclosure relate generally to computer security.

### DESCRIPTION OF THE RELATED ART

In today's distributed computing environments, security is of the utmost importance. Due to the rise of wide-area public networks, users have unlimited access to content, e.g. data, files, applications, programs, etc., from a variety of sources. Additionally, the users' connection to the public networks provides a window for malicious entities to attack the user's computing systems. Malicious entities utilize this ease of accessibility and anonymity to attack the users. For example, the malicious entities can plant viruses, Trojans, or other malicious agents in publicly available content in order to attack the users' computing systems and steal sensitive information from the users and can attack the users' system remotely across the public networks.

To attack a user's computing system, a malicious entity will utilize a vulnerability in the user's computing system. A vulnerability can be any type of weakness, bug, and/or glitch in the software and hardware of a computing system. Accordingly, users can desire to identify any vulnerabilities in their computing systems and the risk the vulnerabilities pose.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 is block diagram of an exemplary environment in which a security tool can test and analyze computing systems, according to various embodiments.

FIGS. 2A and 2B are exemplary diagrams of interfaces generated by the security tool for providing reports, according to various embodiments.

FIG. 3 is a block diagram of an exemplary configuration of the security tool, according to various embodiments.

FIG. 4 is a flow diagram of exemplary processes performed by the security tool, according to various embodiments.

FIG. 5 is a block diagram of an exemplary computing system, according to various embodiments.

### DETAILED DESCRIPTION

For simplicity and illustrative purposes, the principles of the present teachings are described by referring mainly to exemplary embodiments thereof. However, one of ordinary skill in the art would readily recognize that the same principles are equally applicable to, and can be implemented in, all types of information and systems, and that any such variations do not depart from the true spirit and scope of the present teachings. Moreover, in the following detailed description, references are made to the accompanying figures, which illustrate specific exemplary embodiments. Electrical, mechanical, logical and structural changes may be made to the exemplary embodiments without departing from the spirit and scope of the present teachings. The following detailed description is, therefore, not to be taken in a limiting sense and the scope of the present teachings is defined by the appended claims and their equivalents.

Embodiments of the present teachings relate to systems and methods for testing and analyzing vulnerabilities in a computing system. In particular, a security tool can identify vulnerabilities in a computing system and determine a risk level of the vulnerabilities. The security tool can be configured to determine the risk level based on exploits associated with the vulnerabilities. To determine the risk level, the security tool can be configured to identify the exploits associated with a particular vulnerability. Once identified, the security tool can be configured to determine the risk level based on factors associated with the exploits such as whether an exploit exists, a rank of the exploit, a number of exploits that exist for the vulnerability, a difficulty to identify whether the exploit exists, and an effect of the exploit on the vulnerability. The security tool can be configured to generate a report identifying the vulnerabilities of the computing system, the exploits associated with the vulnerabilities, and the risk level of the vulnerabilities. The report can also include links to information about the exploits.

According to embodiments, the security tool can be configured to identify the vulnerabilities and exploits, and determine the risk level, in real time. To achieve this, the security tool can be configured to utilize a database that stores known vulnerabilities and exploits, details of the known vulnerabilities and exploits, and factors associated with the exploits. Accordingly, the security tool can, in real time, identify and analyze security threats to a computing system and provide details of the threats to a user of the security tool.

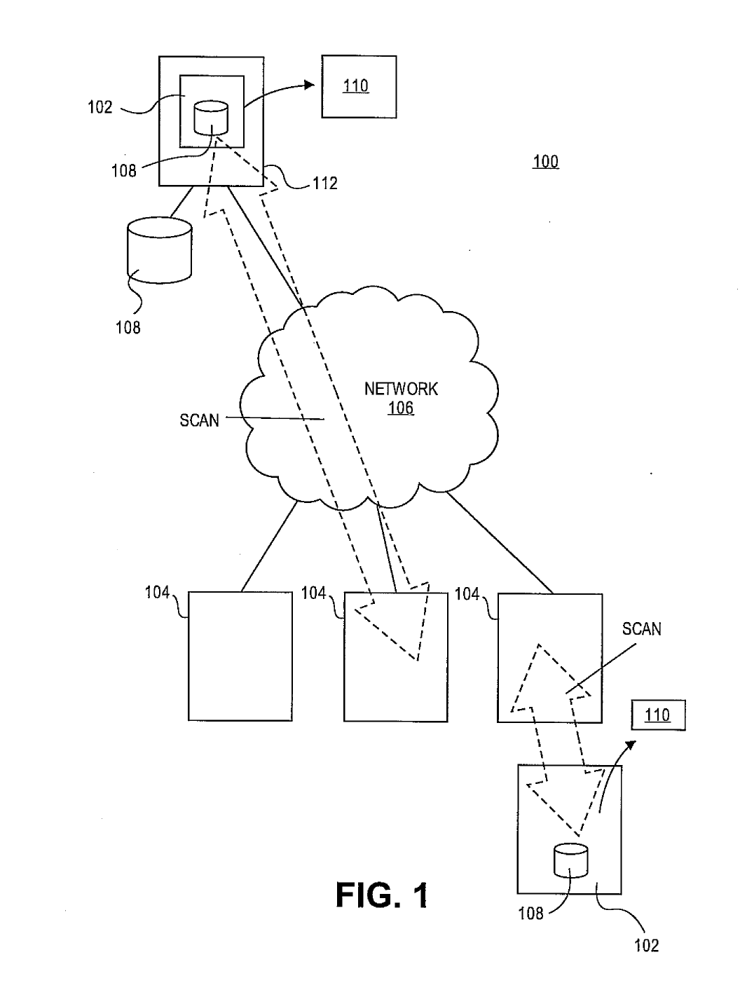

FIG. 1 illustrates an exemplary environment 100 in which a security tool 102 can identify and analyze vulnerabilities in one or more computing systems 104. While FIG. 1 illustrates various systems contained in the environment 100, one skilled in the art will realize that these systems are exemplary and that the environment 100 can include any number and type of systems.

As illustrated in FIG. 1, the environment 100 can represent the systems of public or private entities, such as governmental agencies, individuals, businesses, partnerships, companies, corporations, etc., utilized to support the entities. The computing systems 104 can be any type of conventional computing systems, such as desktops, laptops, servers, etc. The computing systems 104 can include hardware resources, such as processors, memory, network hardware, storage devices, and the like, and software resources, such as operating systems (OS), application programs, and the like.

The computing systems 104 in the environment 100 can be located at any location, whether located at single geographic location or remotely located from each other. For example, the computing systems 104 can represent the computing systems of a company that is located in multiple geographic locations. As such, one or more of the computing systems 104 can be located at one location (e.g. one office of the company) and one or more of the computing system 104 can be located at one or more different locations (e.g. satellite offices of the company). In order to communicate and share data, the computing systems 104 can be coupled to one or more networks 106. The one or more networks 106 can be any type of communications networks, whether wired or wireless, to allow the computing system to communicate, such as wide-area networks or local-area networks.

In embodiments, the owners, administrators, and users of the computing systems 104 can desire to test and analyze the security of the computing systems 104. To achieve this, the security tool 102 can be utilized to test and analyze the security of the computing systems 104. The security tool 102 can be configured to run on one or more of the computing systems 104. The security tool 102 can be configured to identify vulnerabilities in the computing system 104 and to analyze the vulnerabilities in the computing systems 104 in order to determine a risk level the vulnerabilities pose the computing systems 104. A vulnerability can be any type of weakness, bug, and/or glitch in the software resources and/or hardware resources of the computing system 104 that can allow the security of the computing system 104 to be compromised. For example, a vulnerability in the software resources can include, for example, software that is out of date, software that has known security weakness, configurations of software that have known security weaknesses, known bugs of software, etc. Likewise, a vulnerability in the hardware resources can include, for example, known bugs in hardware, configurations of hardware that have known security weaknesses, etc.

In embodiments, in order to identify a vulnerability, the security tool 102 can be configured to examine a computing system 104 to identify the software resources and the hardware resources of the computing system 104. For example, the security tool 102 can be configured to scan the computing systems 104 in order to identify the details of the software resources of the computing systems (type of software installed, e.g. OS and application programs, version of the software installed, configuration of the software installed, etc.) and the details of the hardware resources (type of hardware, configuration of the hardware, etc.).

In embodiments, once the software and hardware resources are identified, the security tool 102 can be configured to compare the details of the software resources and the details of the hardware resources to a vulnerability database 108. The vulnerability database 108 can be configured to store a record of known vulnerabilities for various types of known software resources and hardware resources. The security tool 102 can be configured to compare the identified details of the software resources and hardware resources of the computing system 104 to the vulnerability database 108 in order to identify vulnerabilities in the computing system 104. The vulnerability database 108 can be configured according to any type of proprietary or open-source database format or scheme.

In embodiments, once the vulnerabilities for a computing system 104 are identified, the security tool 102 can be configured to determine if the vulnerabilities are exploitable. To achieve this, the security tool 102 can be configured to determine any exploits that are associated with the identified vulnerabilities. An exploit can be a theoretical or actual method for utilizing a vulnerability in order to compromise a computing system. For example, an exploit can be a procedure, algorithm, application program, data, series of commands, etc. that can utilize the vulnerability to compromise the security of a computing system.

In embodiments, the vulnerability database 108 can be configured to store known exploits associated with the vulnerabilities stored in the vulnerability database 108. The vulnerability database 108 can be configured to store the identification of the exploits and details of the exploits. The details of the exploits can include, for example, a rank of the exploits, whether the exploits works, effects of the exploits on the vulnerability, description of the exploits (e.g. algorithm, procedure), and a copy of the exploit (e.g. copy of code, application program, instruction, etc.). In order to identify exploits for identified vulnerabilities, the security tool 102 can be configured to search the vulnerability database 108 and to retrieve the known exploits from the vulnerability database 108 when the vulnerabilities are identified.

In embodiments, once the vulnerabilities and exploits are identified, the security tool 102 can be configured to determine a risk level of each vulnerability. The risk level can be any type of textual description and/or alphanumeric identifier that describes the possible threat to the security of the computing system 104, which the vulnerability poses. Table 1 illustrates various exemplary risk levels that can be determined for a vulnerability. In Table 1, the risk levels are ordered from 1. to 3. with 1. being the least severe and 3. being the most severe.

TABLE 1

| | |
|---|---|
| 1. | Low |
| 2. | Moderate |
| 3. | High |

In embodiments, the security tool 102 can be configured to determine the risk level based on a variety of factors associated with the identified exploits. For example, the security tool 102 can be configured to determine the risk level based on factors such as whether the exploit exists, whether the exploit works, a rank of the exploit, a number of exploits that exist for the vulnerability, a difficulty to identify whether the exploit exists, and an effect of the exploit on the vulnerability.

In embodiments, the security tool 102 can be configured to determine the risk level based on the rank of an identified exploits associated with an identified vulnerability. To achieve this, the vulnerability database 108 can be configured to store a rank for each exploit in the vulnerability database 108. The rank can be any type of textual description and/or alphanumeric ranking that describes the technical expertise required to utilize the exploit, the effectiveness of the exploit, a reliability of the exploit, stability of the exploit, and/or capabilities of the exploit. Table 2 illustrates different exemplary ranks that can be utilized by the security tool 102. In Table 2, the ranks are ordered from 1. to 7. with 1. being the most difficult and least effective exploit and 7. being the easiest and most effective exploit.

TABLE 2

| | |
|---|---|
| 1. | Manual Ranking |
| 2. | Low Ranking |
| 3. | Average Ranking |
| 4. | Normal Ranking |
| 5. | Good Ranking |
| 6. | Great Ranking |
| 7. | Excellent Ranking |

While Table 2 describes one type of rank system of the exploits, one skilled in the art will realize that the vulnerability database 108 can store any type of rank which describes the technical expertise required to utilize the exploit, the effectiveness of the exploit, the reliability of the exploit, the stability of the exploit, and capabilities of the exploit. For example, as illustrated in Table 3, the vulnerability database 108 can be configured to store a rank that textually describes the technical expertise required to utilize the exploit. In Table 3, the ranks are ordered from 1. to 3. with 1. requiring the most technical expertise to utilize and 3. requiring the least technical expertise to utilize.

TABLE 3

| | |
|---|---|
| 1. | Expert |
| 2. | Intermediate |
| 3. | Novice |

In embodiments, the security tool 102 can be configured to utilize the rank of an identified exploit and the other factors associated with the identified exploits in order to determine the risk level for an identified vulnerability. To achieve this, the security tool 102 can be configured to retrieve the details of the identified exploit (rank, whether the exploit works, effects of the exploit, etc.), when the identified exploit is identified, from the vulnerability database 108. Once the details are retrieved, the security tool 102 can be configured to base the risk level for an identified vulnerability on any combination of the factors associated with the identified exploits. To determine the risk level, the security tool 102 can be configured to include rules that define how each factor will be used and weighed to determine the risk level.

For example, if the security tool 102 fails to identify any exploits for an identified vulnerability, the security tool 102 can determine that the risk level is 1.—Low because exploits do not exist for the identified vulnerability. Likewise, for example, if the security tool 102 identifies five exploits for an identified vulnerability and one of the exploits is ranked 7.—Excellent Ranking, the security tool 102 can determine that the risk level for the identified vulnerability is 3.—High. In other words, the risk level is High due to the ease and effectiveness of the exploit and the number of identified exploits. For further example, if the security tool 102 identifies five exploits for an identified vulnerability and all the exploits are ranked 2.—Low Ranking, the security tool 102 can determine that the risk for the identified vulnerability is 1.—Low. In other words, while five exploits exist, the risk level is Low due to the difficulty and ineffectiveness of the exploit.

While several examples for determining the risk level are described above, one skilled in the art will realize that the security tool 102 can be configured to base the risk level for an identified vulnerability on any combination of the factors associated with the identified exploits. Accordingly, the security tool 102 can be configured to include any rule that utilizes one or more of the factors and any weight for the factors to determine the risk level.

In embodiments, the security tool 102 can be configured to utilize other metrics, in combination with the factors of the exploits, in order to determine the risk level for an identified vulnerability, or configured to determine other risk scores for the identified vulnerability to include with the risk level. For example, the security tool 102 can be configured to utilize known risk scoring systems, such as Common Vulnerability Scoring System (CVSS), as additional metrics for determining the risk level for an identified vulnerability or for determining other risk scores for the identified vulnerabilities to include with the risk level. A complete description of the CVSS can be found in CVSS, A Complete Guide to the Common Vulnerability Scoring System Version 2.0 by Peter Men, Karen Scarfone, and Sasha Romanosky, June 2007, which is incorporated herein in its entirety by reference.

In embodiments, once the vulnerabilities are identified and the risk level determined, the security tool 102 can be configured to provide a report 110 to a user of the security tool 102 and/or a user of the computing system 104. The report 110 can be configured to include the identified vulnerabilities, identified exploits, the risk level, the rank of the exploits, and other relevant information. The security tool 102 can be configured to provide the report 110 in any type of format that is accessible by a user of the security tool 102 and/or the computing system 104. For example, the security tool 102 can be configured to create and output a graphical user interface (GUI) that includes the report 110. Likewise, the security tool 102 can be configured to output the report 110 in other formats, such as electronic mail (email), Hyper Text Markup Language (HTML) document, text or word processing document, and the like.

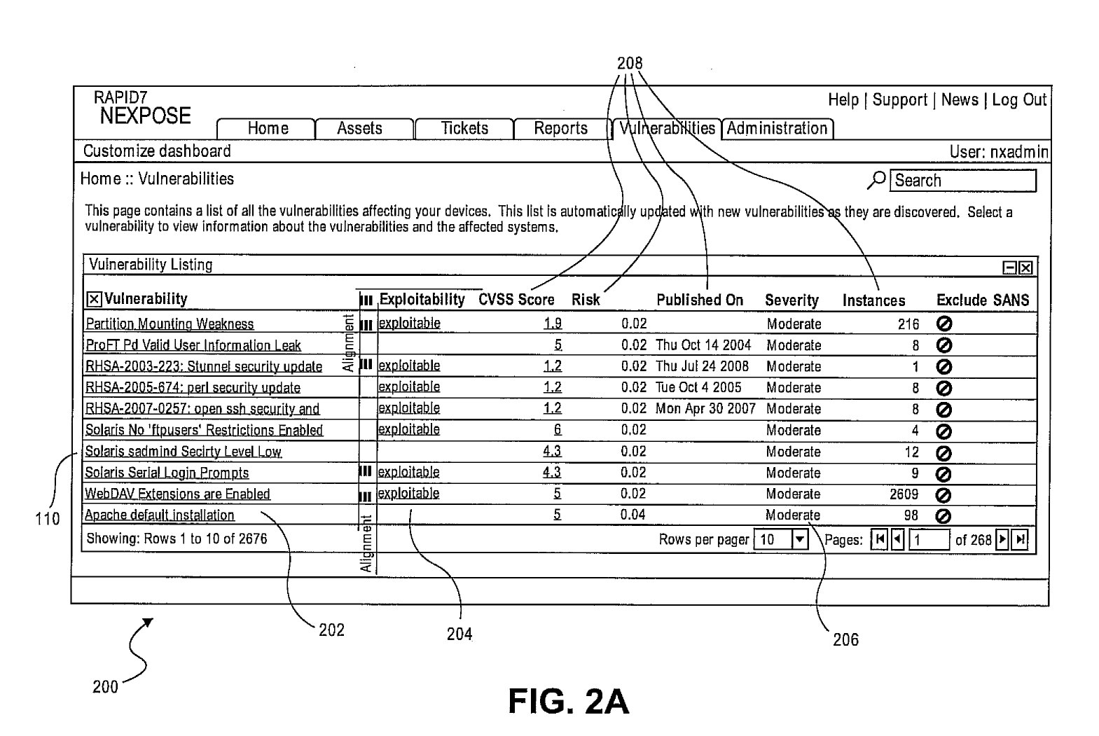

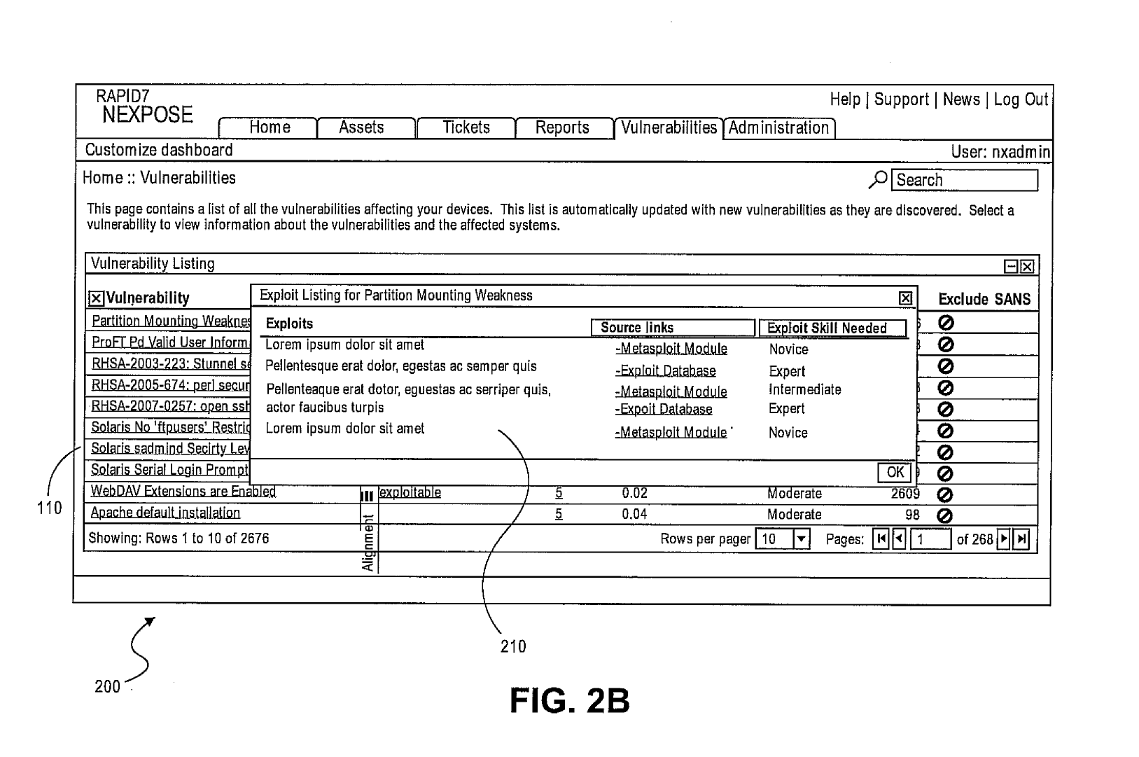

FIG. 2A illustrates an exemplary GUI 200 for displaying the report 110. The GUI 200 can be a GUI utilized to communicate with the security tool 102 in order to control the security tool 102 and receive the report 110. As illustrated, the GUI 200 can display the report 110. The report 110 can be configured as a table that includes a column 202 for displaying the vulnerabilities identified. The column 202 can include the identification of each identified vulnerability (e.g. name). This identification can also be a link that allows the user to retrieve more information about the vulnerability, for example, more information stored in the vulnerability database 108.

The report 110 can also include a column 204 that identifies whether an identified vulnerability is exploitable, i.e. whether an exploit exists. In the report 110, the column 204 can include a link to the details of identified exploits stored in the vulnerability database 108. The link can be configured to allow a user of the security tool 102 and/or computing system 104 to view the details of the identified exploits such as a description of the vulnerabilities, a description of the exploits, the rank of the exploits, and the like. FIG. 2B illustrates details 210 that can be output once a link is selected in column 204. As illustrated, the details 210 can include the details about the exploits stored in the vulnerability database, such as name of the exploits, source of the exploit, and rank of the exploit.

The report 110 can also include a column 206 that includes the risk level for each identified vulnerability. The report 110 can also include columns 208 that include other information about the identified vulnerabilities, such as CVSS score, other types of risk scores, date the vulnerability or exploit was published, number of instances of the identified vulnerabilities, etc.

In embodiments, when determining the exploits as described above, the security tool 102 can be configured to verify that an identified exploit works on an identified vulnerability. For example, an identified exploit can be theoretical, e.g. unconfirmed that it can be utilized on the identified vulnerability to compromise a computing system. The security tool 102 can be configured to perform the identified exploit on the identified vulnerability in a computing system 104 to determine if the exploit works. The security tool 102 can be configured to provide notification of the verification in the report 110. Likewise, the security tool 102 can modify the risk level of the vulnerability and the rank of the exploit based on the verification. For example, if the exploit does not work, the security tool 102 can downgrade the risk level of the vulnerability and the rank of the exploit.

In embodiments, additionally, the security tool 102 can be configured to perform the identified exploits on the identified vulnerability in a computing system 104 to determine if the exploits work and to validate the identified vulnerability. For example, if the known exploits do not work on an identified vulnerability, the identified vulnerability may not be an actual and real vulnerability because no exploits exists to use the vulnerability. The security tool 102 can be configured to validate a particular vulnerability from the identified vulnerabilities based on verification of the exploits. For example, if one of the identified exploits works on an identified vulnerability, the security tool 102 can classify and validate the identified vulnerability as a real vulnerability. Likewise, for example, if none of the exploits work, the security tool 102 can determine that the vulnerability is not real, and can remove the vulnerability from the identified vulnerabilities or classify the identified vulnerability as not real.

In embodiments, the security tool 102 can be configured to utilize stored details of the exploits associated with the vulnerabilities in order to initially identify the vulnerabilities. When initially identifying vulnerabilities, the security tool 102 can be configured to search the vulnerability database 108 to identify the exploits associated with a particular vulnerability. Once identified, the security tool 102 can be configured to extract the details for the identified exploits. Once extracted, the security tool 102 can be configured to utilize the details to enhance the identification of the vulnerabilities in the computing system 104.

For example, the vulnerability database 108 can include an entry for a vulnerability in the passwords for the Windows® operating system by Microsoft® Corporation. The vulnerability database 108 can include various exploits associated with the vulnerability in the passwords for Windows® operating system. For example, the vulnerability database 108 can include an exploit for attacking Windows' password using password hashes, such “pass the hash” technique, and can include the details for the exploit such as routines, instructions, code, programs, etc. for performing the exploit. In this example, the “pass the hash” technique involves utilizing the hash of passwords, stored by the Windows operating system, to gain access to the computing system 104. To initially identify vulnerabilities in the computing system 104, the security tool 102 can search and extract the details of the password hash exploit (routines, instructions, code, programs, etc.) from the vulnerability database 108. Once extracted, the security tool 102 can scan the computing system 104 for a password hash file and perform the password hash exploit in order to identify a vulnerability in the passwords of the Windows operating system.

In embodiments, as described above, the security tool 102 can be configured as an application program that is capable of being stored on and executed by the computing systems of the environment 100. For example, the security tool 102 can be an application program such as NeXpose™ from Rapid7, LLC. The security tool 102 can be written in a variety of programming languages, such as JAVA, C++, Python code, Visual Basic, hypertext markup language (HTML), extensible markup language (XML), and the like to accommodate a variety of operating systems, computing system architectures, etc.

In embodiments, as described herein, the security tool 102 can be implemented and executed on any of the computing systems of environment 100 in order to test and analyze the security of a computing system 104. For example, the security tool 102 can be implemented and executed on a computing system 104 that is being tested. Likewise, the security tool 102 can be implemented and executed on a remote computing system 112. In this example, the security tool 102 can remotely test and analyze the computing systems 104 via the network 106. When configured as an application program, the security tool 102 can be stored on any type of computer readable storage medium, such as hard drives, optical storage, system memory, and the like, of the computing systems of the environment 100.

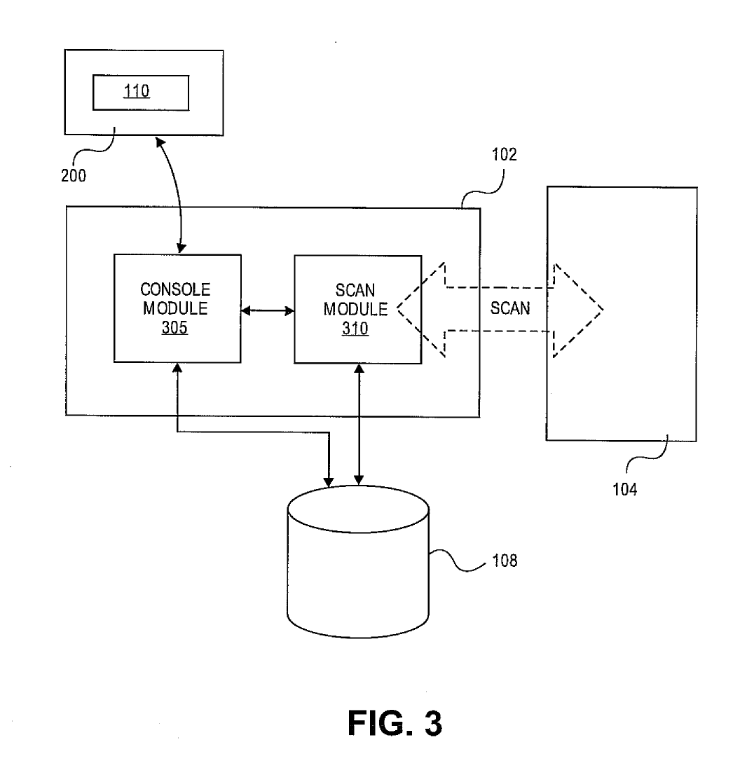

FIG. 3 is a block diagram of an exemplary configuration of the security tool 102. As illustrated, the security tool 102 can include a console module 305 and scan module 310. While FIG. 3 illustrates various components of the security tool 102, one skilled in the art will realize that existing components can be removed or additional components added.

In embodiments, the console module 305 can be configured to provide an interface to the security tool 102. The console module 305 can be configured to generate interfaces that allow a user to initiate the security tool 102, operate the security tool 102, and receive information generated by the security tool 102, such as report 110. To achieve this, the console module 305 can be configured to include the necessary logic, commands, instructions and routines to generate and communicate with GUIs and/or command-line interfaces. Likewise, the console module 305 can be configured include the necessary logic, commands, instructions and routines to output information in other formats, such as email, HTML document, text or word processing document, and the like.

In embodiments, the console module 305 can communicate with the scan module 310. The scan module 310 can be configured to perform the processes of identifying the vulnerabilities and exploits of the computing systems 104. To achieve this, the scan module 310 can be configured to include the necessary logic, commands, instructions and routines to scan the computing systems 104 in order to identify the hardware resources and the software resources of the computing systems 104. Likewise, the scan module 310 can be configured to include the necessary logic, commands, instructions and routines to search the vulnerability database 108 and to retrieve the information from the vulnerability database 108 in order to identify the vulnerabilities and exploits of the computing systems 104 and to report the identified vulnerabilities and exploits to the console module 305.

In embodiments, the console module 305 can be configured to determine the risk level utilizing the process described herein. To achieve this, the console module 305 can be configured to include the necessary logic, commands, instructions and routines to determine the risk level based on the factors associated with the identified exploits and any other risk factors. Likewise, the console module 305 can be configured to communicate with the vulnerability database 108 in order to retrieve information about the vulnerabilities and exploits and to provide the information to the user of the security tool 102.

In embodiments, as illustrated in FIG. 3, the console module 305 and the scan module 310 can be implemented in a single application program capable of executing on the computing systems of environment 100. Likewise, the console module 305 and the scan module 310 can be implanted as separate application programs that are capable of executing on separate computing systems of the environment 100. Additionally, the console module 305 can be configured to communicate with multiple scan modules 310.

In embodiments, as illustrated in FIG. 1, the security tool 102 can be configured to include the vulnerability database 108. Likewise, the vulnerability database 108 can be stored in a repository associated with any of the computing systems of the environment 100 and accessed remotely by the security tool 102. The repository can be stored any type of computer readable storage medium, such as hard drives, optical storage, system memory, and the like, of the computing systems of the environment 100. While FIG. 1 illustrates a single vulnerability database 108, one skilled in the art will realize that the vulnerability database 108 can comprise multiple databases. For example, the vulnerability database 108 can include a database for vulnerabilities and a database for exploits.

In embodiments, as described above, the security tool 102 can be configured to test a single computing system 104 for security threats. Likewise, the security tool 102 can be configured to scan and test multiple computing systems 104, concurrently, for security threats.

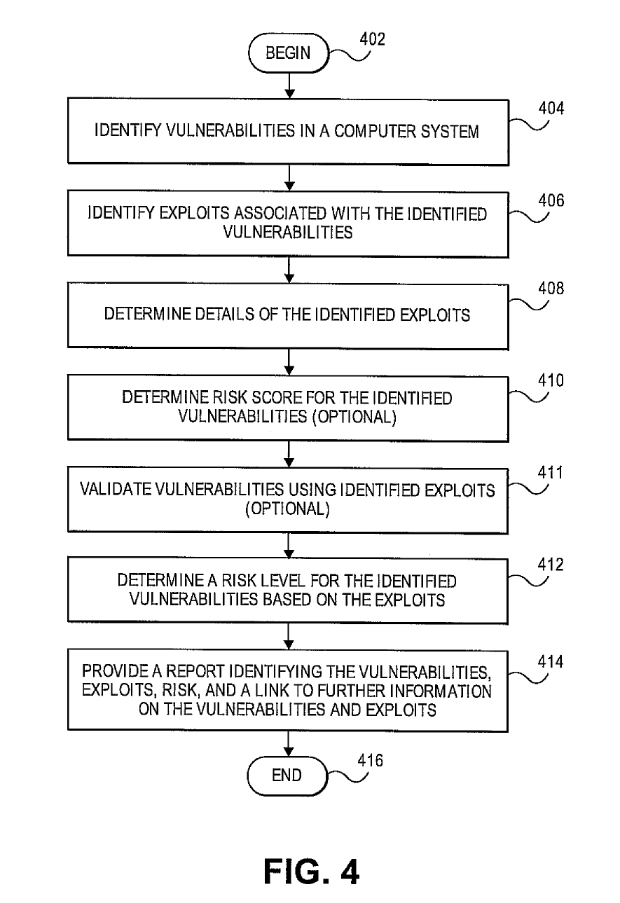

As mentioned above, the security tool 102 can be configured to test and analyze a computing system. FIG. 4 is a flow diagram that illustrates an exemplary process by which security tool 102 can test and analyze vulnerabilities in a computing system 104. In 402, the process can begin.

In 404, the security tool 102 can identify vulnerabilities in a computing system 104. The security tool 102 can examine the computing system 104 to identify the software resources and the hardware resources of the computing system 104. For example, the security tool 102 can scan the computing systems 104 in order to identify the details of the software resources of the computing systems (type of software installed, e.g. OS and application programs, version of the software installed, configuration of the software installed, etc.) and the details of the hardware resources (type of hardware, configuration of the hardware, etc.). Once the software and hardware resources are identified, the security tool 102 can compare the identified details of the software resources and hardware resources of the computing system 104 to the vulnerability database 108 in order to identify vulnerabilities in the computing system 104.

In 406, the security tool 102 can identify exploits associated with the identified vulnerabilities. The security tool 102 can search the vulnerability database 108 and to retrieve the known exploits from the vulnerability database 108 when the vulnerabilities are identified. In 408, the security tool 102 can determine the details of the identified exploits. The security tool 102 can retrieve the details from the vulnerability database 108. Likewise, the security tool 102 can optionally test the exploits on the identified vulnerabilities to determine if the exploits work on the vulnerabilities.

In 410, the security tool 102 can optionally determine other risk scores for the identified vulnerabilities. The security tool 102 can determine other risk scores such as CVSS for the identified vulnerabilities.

In 411, the security tool 102 can optionally validate the identified vulnerabilities using the identified exploits. For a particular vulnerability, the security tool 102 can perform the identified exploits on the particular vulnerability to verify that the exploits work. The security tool 102 can validate the identified vulnerabilities based on the verification, such as classifying a particular vulnerability as real.

In 412, the security tool 102 can determine a risk level for the identified vulnerabilities based on the exploits. The security tool 102 can base the risk level for an identified vulnerability on any combination of the factors associated with the identified exploits or other risk scoring systems. To determine the risk level, the security tool 102 can include rules that define how each factor will be used and weighed to determine the risk level.

In 414, the security tool 102 can provide a report 110 identifying the vulnerabilities, exploits, risk, and a link to further information on the vulnerabilities and exploits. The report 110 can include the identified vulnerabilities, identified exploits, the risk level, the rank of the exploits, and other relevant information. The security tool 102 can provide the report 110 in any type of format that is accessible by a user of the security tool 102 and/or the computing system 104.

In 416, the process can end, return to any point or repeat.

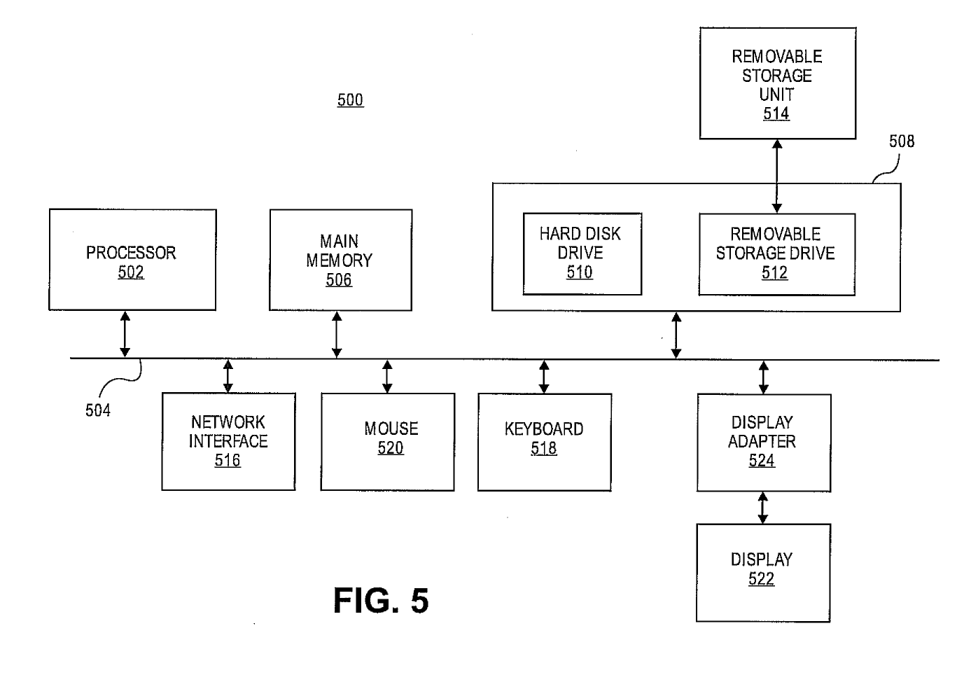

FIG. 5 illustrates an exemplary block diagram of a computing system 500 which can be implemented as the computing systems 104 and/or the computing system 112 according to various embodiments. In embodiments, the security tool 102 can be stored and executed on the computing system 500 in order to perform the process described above. Likewise, the security tool 102 can be stored and executed remotely and can be configured to communicate with the computing system 500 in order to perform the process described above. While FIG. 5 illustrates various components of the computing system 500, one skilled in the art will realize that existing components can be removed or additional components can be added.

As shown in FIG. 5, the computing system 500 can include one or more processors, such as processor 502 that provide an execution platform for embodiments of the security tool 102. Commands and data from the processor 502 are communicated over a communication bus 504. The computing system 500 can also include a main memory 506, for example, one or more computer readable storage media such as a Random Access Memory (RAM), where the security tool 102 and other application programs, such as an operating system (OS) can be executed during runtime, and can include a secondary memory 508. The secondary memory 508 can include, for example, one or more computer readable storage media or devices such as a hard disk drive 510 and/or a removable storage drive 512, representing a floppy diskette drive, a magnetic tape drive, a compact disk drive, etc., where a copy of a application program embodiment for the security tool 102 can be stored. The removable storage drive 512 reads from and/or writes to a removable storage unit 514 in a well-known manner. The computing system 500 can also include a network interface 516 in order to connect with the one or more networks 106.

In embodiments, a user can interface with the computing system 500 and operate the security tool 102 with a keyboard 518, a mouse 520, and a display 522. To provide information from the computing system 500 and data from the security tool 102, such as the report 110, the computing system 500 can include a display adapter 524. The display adapter 524 can interface with the communication bus 504 and the display 522. The display adapter 524 can receive display data from the processor 502 and convert the display data into display commands for the display 522.

Certain embodiments may be performed as a computer application or program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include computer readable storage devices and media, and signals, in compressed or uncompressed form. Exemplary computer readable storage devices and media include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present teachings can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the teachings has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. Those skilled in the art will recognize that these and other variations are possible within the spirit and scope as defined in the following claims and their equivalents.

What is claimed is:

1. A method for security testing, comprising:
identifying a vulnerability in a computing system;
identifying whether an exploit is associated with the vulnerability;
determining a risk level of the vulnerability based on the exploit; and
providing a report identifying the vulnerability and the risk level of the vulnerability.

2. The method of claim 1, wherein the report further comprises:
a link to information describing the exploit.

3. The method of claim 1, wherein the vulnerability comprises at least one of a vulnerability in software of the computing system and a vulnerability in hardware of the computing system.

4. The method of claim 1, wherein the risk level is based on at least one of whether the exploit exists, a rank of the exploit, a number of exploits that exist for the vulnerability, a difficulty to identify whether the exploit exists, and an effect of the exploit on the vulnerability.

5. The method of claim 1, wherein identifying whether an exploit is associated with the vulnerability comprises:
querying, in real-time upon identification of the vulnerability, a database of exploits to determine whether any exploits are associated with the vulnerability.

6. The method of claim 1, the method further comprising:
determining a rank of the exploit, wherein the rank is based on at least one of a level of expertise required to utilize the exploit, an effectiveness of the exploit, a reliability of the exploit, stability of the exploit, and capabilities of the exploit.

7. The method of claim 1, the method further comprising:
testing the exploit on the vulnerability to verify that the exploit works on the vulnerability; and
determining the risk level based on a result of the testing.

8. The method of claim 7, the method further comprising:
providing, in the report, the result of the testing.

9. The method of claim 1, the method further comprising:
testing the exploit on the vulnerability to verify that the exploit works on the vulnerability; and
validating the vulnerability based on a result of the testing.

10. The method of claim 1, wherein identifying the vulnerability in the computing system, comprises:
determining details of an existing exploit associated with the vulnerability; and
utilizing the details of the existing exploit to identify the vulnerability.

11. A computer readable storage medium embodying instruction for causing a processor to perform the method comprising:
identifying a vulnerability in a computing system;
identifying whether an exploit is associated with the vulnerability;
determining a risk level of the vulnerability based on the exploit; and
providing a report identifying the vulnerability and the risk level of the vulnerability.

12. The computer readable storage medium of claim 11, wherein the report further comprises:
a link to information describing the exploit.

13. The computer readable storage medium of claim 11, wherein the vulnerability comprises at least one of a vulnerability in software of the computing system and a vulnerability in hardware of the computing system.

14. The computer readable storage medium of claim 11, wherein the risk level is based on at least one of whether the exploit exists, a rank of the exploit, a number of exploits that exist for the vulnerability, a difficulty to identify whether the exploit exists, and an effect of the exploit on the vulnerability.

15. The computer readable storage medium of claim 11, wherein identifying whether an exploit is associated with the vulnerability comprises:
querying, in real-time upon identification of the vulnerability, a database of exploits to determine whether any exploits are associated with the vulnerability.

16. The computer readable storage medium of claim 11, the method further comprising:
determining a rank of the exploit, wherein the rank is based on at least one of a level of expertise required to utilize the exploit, an effectiveness of the exploit, a reliability of the exploit, stability of the exploit, and capabilities of the exploit.

17. The computer readable storage medium of claim 11, the method further comprising:
testing the exploit on the vulnerability to verify that the exploit works on the vulnerability;
determining the risk level based on a result of the testing; and
providing, in the report, the result of the testing.

18. The computer readable storage medium of claim 11, the method further comprising:
testing the exploit on the vulnerability to verify that the exploit works on the vulnerability; and
validating the vulnerability based on a result of the testing.

19. The computer readable storage medium of claim 11, wherein identifying the vulnerability in the computing system, comprises:
determining details of an existing exploit associated with the vulnerability; and
utilizing the details of the existing exploit to identify the vulnerability.

20. A system for testing security, comprising:
a processor; and
a computer readable storage medium coupled to the processor and comprising instruction for causing the processor to perform the method comprising:
identifying a vulnerability in a computing system;
identifying whether an exploit is associated with the vulnerability;
determining a risk level of the vulnerability based on the exploit; and
providing a report identifying the vulnerability and the risk level of the vulnerability.

21. The system of claim 20, wherein the report further comprises:
a link to information describing the exploit.

22. The system of claim 20, wherein the vulnerability comprises at least one of a vulnerability in software of the computing system and a vulnerability in hardware of the computing system.

23. The system of claim 20, wherein the risk level is based on at least one of whether the exploit exists, a rank of the exploit, a number of exploits that exist for the vulnerability, a difficulty to identify whether the exploit exists, and an effect of the exploit on the vulnerability.

24. The system of claim 20, wherein identifying whether an exploit is associated with the vulnerability comprises:
querying, in real-time upon identification of the vulnerability, a database of exploits to determine whether any exploits are associated with the vulnerability.

25. The system of claim 20, the method further comprising:
determining a rank of the exploit, wherein the rank is based on at least one of a level of expertise required to utilize the exploit, an effectiveness of the exploit, a reliability of the exploit, stability of the exploit, and capabilities of the exploit.

26. The system of claim 20, the method further comprising:
testing the exploit on the vulnerability to verify that the exploit works on the vulnerability;
determining the risk level based on a result of the testing; and
providing, in the report, the result of the testing.

27. The system of claim 20, the method further comprising:
testing the exploit on the vulnerability to verify that the exploit works on the vulnerability; and
validating the vulnerability based on a result of the testing.

28. The system of claim 20, wherein identifying the vulnerability in the computing system, comprises:
determining details of an existing exploit associated with the vulnerability; and
utilizing the details of the existing exploit to identify the vulnerability.
